(19) United States
(12) Patent Application Publication
(10) Pub. No.: US 2013/0258469 A1
(43) Pub. Date: Oct. 3, 2013

(54) SPATIAL BEAM COMBINING FOR MULTIPLE DIODE LASER ELEMENTS

(71) Applicant: OCLARO, INC., San Jose, CA (US)

(72) Inventors: Sang-Ki Park, Tucson, AZ (US); Oscar D. Romero, JR., Tucson, AZ (US); Trevor Crum, Tucson, AZ (US); Ed Wolak, Tuscon, AZ (US)

(21) Appl. No.: 13/787,546

(22) Filed: Mar. 6, 2013

Related U.S. Application Data
(60) Provisional application No. 61/619,394, filed on Apr. 2, 2012.

(51) Int. Cl. G02B 27/28; G02B 5/04; G02B 27/30

(52) U.S. Cl. CPC G02B 27/283; G02B 27/30; G02B 5/04
USPC 359/485.01; 359/641; 359/834

(57) ABSTRACT

In order to achieve a high brightness optical source with both spatial size and numeric aperture ideal for fiber coupling, an assembly of multiple individually collimated laser diode chips on submount (COS) are mounted onto a common flat surface and redirected through a series of optical components. This is done in such a manner which allows for active reduction of both overall spot size and numeric aperture. This optical stacking technique achieves a high brightness source which is also suitable for directly coupling into an optical fiber, or can achieve enhanced brightness through the use of existing polarization or wavelength combining schemes prior to fiber optic coupling.

### BACKGROUND CROSS-REFERENCE TO RELATED APPLICATION(S)

This application claims priority under 35 C. §119(e) to Provisional Patent Application Ser. No. 61/619,394, titled “Spatial Beam Multiplexing For Multiple Emitters,” filed on Apr. 2, 2012. The subject matter of the foregoing is incorporated herein by reference in its entirety.

### BACKGROUND

1. Field of Disclosure

This disclosure relates to the field of beam multiplexing generally, and specifically to improved spatial beam multiplexing to facilitate coupling optical radiation into a fiber.

2. Description of the Related Art

Presently, systems and methods for beam multiplexing generally combine beams in a vertical manner. In order to stack the beam profiles one or more of the laser diodes that generate the beams are placed on mechanical steps such that the height of each laser diode is different from one other. The mechanical steps add additional material between the laser diode and an associated heat sink. Thus, the thermal dissipation of the laser diodes is not uniform, and not as efficient as direct COS soldering to housing. Additionally, the mechanical steps are generally machined to a fixed height and set of mechanical tolerances. The mechanical tolerances of the mechanical steps limit the distances between beam profiles, and accordingly may limit the numerical aperture and/or coupling efficiency of the combined beams with a fiber.

### SUMMARY

An assembly includes a first laser diode, a second laser diode, a first collimating assembly, a second collimating assembly, a first redirecting device, and a second redirecting device. In one embodiment, the first laser diode produces a first beam, and the first laser diode is part of a first chip on a submount (COS) that is mounted to a flat surface. The second laser diode produces a second beam, and the second laser diode is part of second COS that is adjacent to the first COS and is mounted to the flat surface. The first collimating assembly collimates the first beam to form a first collimated beam, such that the first collimated beam has a first spatial beam profile. The second collimating assembly collimates the second beam to form a second collimated beam that is parallel to the first collimated beam, such that the second collimated beam has a second spatial beam profile. The first redirecting device adds a vertical offset to the first collimated beam, changes the direction of propagation of the first collimated beam, and rotates the first spatial beam profile of the first collimated output beam by 90 degrees such that the first spatial beam profile has a first vertical elongated side. The second redirecting device is positioned such that the second redirecting device is staggered laterally from the first redirecting device. The second redirecting device adds the vertical offset to the second collimated beam, changes the direction of propagation of the second collimated beam such that the second collimated beam is parallel to the first collimated beam exiting the first redirecting device, and rotates the second spatial beam profile of the second collimated output beam by 90 degrees such that the second spatial beam profile has a second vertical elongated side adjacent to the first vertical elongated side. The second redirecting device allows active translation of the second beam during alignment, thus reducing the unwanted gaps in the beam stacking process. The first and second collimated beams exiting the first and second redirecting devices create a first stacked beam.

In another embodiment, an assembly includes a first laser diode, a second laser diode, a first collimating assembly, a second collimating assembly, a first redirecting device, and a second redirecting device. The first laser diode produces a first beam, and the first laser diode is part of a first chip on a COS that is mounted to a flat surface. The second laser diode produces a second beam, and the second laser diode is part of a second COS that is adjacent to the first COS and is mounted to the flat surface. The first collimating assembly collimates the first beam to form a first collimated beam, such that the first collimated beam has a first horizontal spatial beam profile with a first horizontal elongated side. The second collimating assembly collimates the second beam to form a second collimated beam that is parallel to the first collimated beam, such that the second collimated beam has a second horizontal spatial beam profile with a second horizontal elongated side. The first redirecting device changes the direction of propagation of the first collimated beam. The second redirecting device adds a vertical offset to the second collimated beam and changes the direction of propagation of the second collimated beam such that the second collimated beam is parallel to the first collimated beam exiting the first redirecting device and the second horizontal elongated side is adjacent to the first horizontal elongated side. The first and second collimated beams exiting the first and second redirecting devices create a first stacked beam.

In yet another embodiment a modified right angle prism includes a beam entering surface that is triangular in shape, the beam entering surface includes a first edge that is perpendicular to a bottom surface of the modified right angle prism. A collimated beam perpendicular to, and incident on, the beam entering surface is transmitted by the beam entering surface. The modified right angle prism includes a first reflecting surface that is a 45° cut out between a far side surface and a bottom surface of the modified right angle prism, wherein the far side surface is parallel to the beam entering surface. The modified right angle prism includes a second reflecting surface that is the hypotenuse of the modified right angle prism, such that the collimated beam reflects off the first reflecting surface and then the second reflecting surface, adding a vertical offset to the collimating beam and rotating the collimated beam such that a spatial beam profile of the collimated beam is rotated by 90 degrees. The modified right angle prism also includes a beam exiting surface, rectangular in shape, that transmits the collimated beam reflected from the second reflecting surface, the beam exiting surface intersects the beam exiting surface at the first edge.

### BRIEF DESCRIPTION OF DRAWINGS

FIG. 1 example assembly for spatial multiplexing laser diode beams according to an embodiment.

FIG. 2 shows the laser diode beams spatial beam profile of FIG. 1, after spatial transformation by the prisms according to an embodiment.

FIG. 3 is an illustration of the prism used in FIG. 1 according to an embodiment.

FIG. 4 is an illustration of another prism according to an embodiment.

FIG. 5A shows an array of the prisms in FIG. 4 according to an embodiment.

FIG. 5B shows a side view of the array of the prisms in FIG. 5A according to an embodiment.

FIG. 6 is an illustration of another prism design according to an embodiment.

FIGS. 7A illustrates an exit plane view of the combination of a chip on submount with the prism of FIG. 6 according to an embodiment.

FIGS. 7B illustrates a side view of the combination of a chip on submount with the prism of FIG. 6 according to an embodiment.

FIGS. 7C illustrates a top view of the combination of a chip on submount with the prism of FIG. 6 according to an embodiment.

FIGS. 7D illustrates an isometric view of the combination of a chip on submount with the prism of FIG. 6 according to an embodiment.

FIG. 8 illustrates a bank of four chips on a submount, using the prism of FIG. 6 according to an embodiment.

FIG. 9 is an example assembly for spatial multiplexing laser diode beams, using the prism of FIG. 6 according to an embodiment.

FIG. 10 shows a spatial beam profile of vertically stacked laser diode beams according to an embodiment.

FIG. 11 is an example assembly for spatial multiplexing laser diode beams, to produce the vertical stacking of FIG. 10 according to an embodiment.

FIG. 12A is an illustration of an Amici roof prism according to an embodiment.

FIG. 12B shows an array of the prisms in FIG. 11 according to an embodiment.

FIG. 13A illustrates an exit plane view of the Amici roof prism in FIG. 12A according to an embodiment.

FIG. 13B illustrates a top view of the Amici roof prism in FIG. 12A according to an embodiment.

FIG. 14 illustrates an example optical system for producing vertically offset laser diode beams, according to an embodiment.

FIG. 15 illustrates an example optical system for producing vertically offset laser diode beams, according to another embodiment.

FIG. 16 illustrates an example optical system for producing vertically offset laser diode beams, according to yet another embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

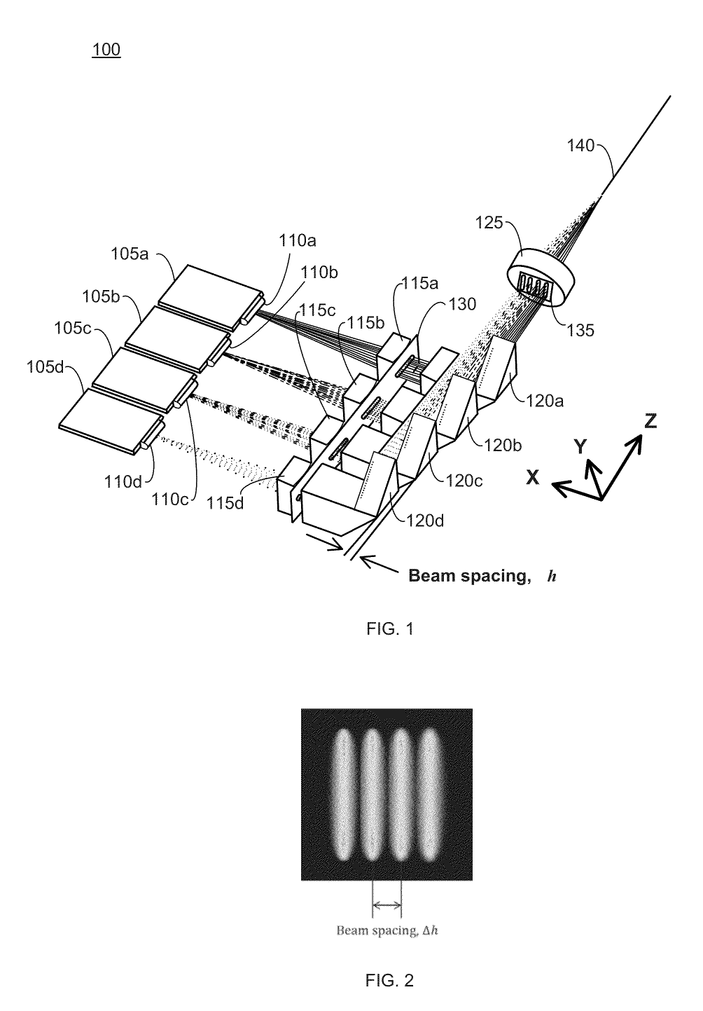

FIG. 1 is an example assembly 100 for spatial multiplexing laser diode beams according to an embodiment. The assembly 100 includes a plurality of chip on submounts (COS)105a-105d, a plurality of fast axis collimators (FACs) 110a-110d, a plurality of slow axis collimators(SACs) 115a-115d, a plurality of prisms 120a-120d, a focusing lens 125; and a fiber 140. The COSs 105a-105d, the FACs 110a-110d, the SACs 115a-115d, and the prisms 120a-120d are all mounted (e.g., bonded or attached via some other means) to a common surface in the X-Z plane. The diode active area heights at each COS 105a-105d are the same as the heights of the collimated beams (at beam center) before entering the prisms 120a-120d. In alternate embodiments, the FACs 110a-110d are bonded directly to their respective COSs 105a-105d, instead of being bonded to the common surface.

The assembly 100 includes COSs 105a, 105b, 105c, and 105d. Each COS contains a laser diode mounted onto a thermal submount. The submount provides thermal management and stability to the laser diode. Each laser diode produces a beam of radiation with a fast axis (i.e. wide divergence, which is in the Y direction in FIG. 1) and a slow axis (i.e., not as wide divergence, which is in the Z direction in FIG. 1). Each of the COSs 105a-105dare positioned in approximately the same X-Z plane such that beams exiting each COSs 105a-d originate at approximately the same height in the Y direction.

The fast axis and slow axis of the beams of radiation from the laser diodes of COSs 105a, 105b, 105c, and 105d are collimated by the FACs 110a, 110b, 110c, and 110d, and the SACs 115a, 115b, 115c, and 115d, respectively. A beam existing any of the SACs 115a-115d is substantially collimated, but it is narrow in the Y direction and elongated in the Z direction. For convenience, the Y direction will be referred to as vertical and the x-z plane as horizontal. Thus, the beam exiting any one of the SACs 115a-115d has a cross section that is horizontally elongated (horizontal spatial beam profile) as illustrated in plane 130. Plane 130 is not a physical item, but is merely present to help illustrate each beam's geometry upon exit from SACs 115a-115d. In alternate embodiments, the beam may not be horizontally elongated. For example, the FACs 110a-110d and SAC 110a-110d may be such that the collimated beam has a circular spatial beam profile at plate 130.

Exiting the SACs 115a-115d, the four beams in FIG. 1 are four horizontally elongated beams that are horizontally displaced from each other as shown in plane 130. The This is a spatial pattern that is difficult to couple efficiently into a fiber as the spatial beam profile for each beam is positioned at the same height and in a manner that makes it difficult to minimize the distance between the spatial beam profiles (e.g., because of the width of each COS). In contrast, the embodiments described herein stack beams in a manner to minimize unwanted optical gaps in the stacking, by the spatial beam profile of the stacked beam, from the optical axis of the element the stacked beam is being coupled to, thus lowering the numerical aperture for item (e.g., fiber) needed for coupling while minimizing power loss.

The prisms 120a-120d each rotate the spatial pattern of their respective beam as seen at plane 130 ninety degrees. Additionally, each prism 120 is positioned such that it is staggered laterally with any adjacent prism. For example, the prism 120b is positioned such that it is offset from the position of the prism 120a in the X direction by Δh. Similarly, each subsequent prism is further offset by Δh in the X direction. Thus, 120c is offset from 120b an additional Δh in the X direction, and 120d is offset from 120c an additional Δh in the X direction. The spacing of prisms 120a-120d stacks the rotated beams to create a stacked beam with the spatial beam profile shown by plane 135 and further illustrated by FIG. 2.

FIG. 2 shows the laser diode beams spatial beam profile of FIG. 1, after spatial transformation by prisms 120a-120d according to an embodiment. Here, the four beams have been rotated by 90 degrees so that they are now elongated in the vertical direction, rather than in the horizontal direction. The spatial beam pattern of each beam having at least one elongated vertical side adjacent to one elongated vertical side of another beam's spatial beam pattern. The four vertically elongated beams are spaced apart by Δh in the X direction. Typical values of Δh range from, for example, ˜200 to 700 microns. The spatial beam pattern of the stacked beam is more square than the spatial pattern of the beams at plane 130. Accordingly, the numerical aperture required for efficient coupling is less than, for example, the spatial beam profile at plane 130. Referring back to FIG. 1, the assembly includes the focusing lens 135. The focusing lens 135 couples the beams into a fiber 140.

One advantage of this approach is that the COSs 105a-105d, SACs 115a-115d, and prisms 120a-120d can be attached on a common flat surface. This simplifies assembly and reduces the component count/cost. Additionally, this helps ensure a common thermal profile across each of the COSs 105a-105d, and better heat dissipation due to reduced thermal path. Moreover, beams from each of the COSs 105a-105d may be aligned precisely using by positioning the prisms 120a-120d to minimize Δh, thus reducing the numerical aperture needed for efficient coupling to the fiber 140. For example, the resulting configuration may result in an average thermal resistance reduction of roughly 10% and an effective N.A. reduction due to active stacking of roughly 10%.

Another advantage is that the prisms of the same geometry can be used for all four beams, rather than using a slightly different prism for each beam. This reduces the component count and overall cost.

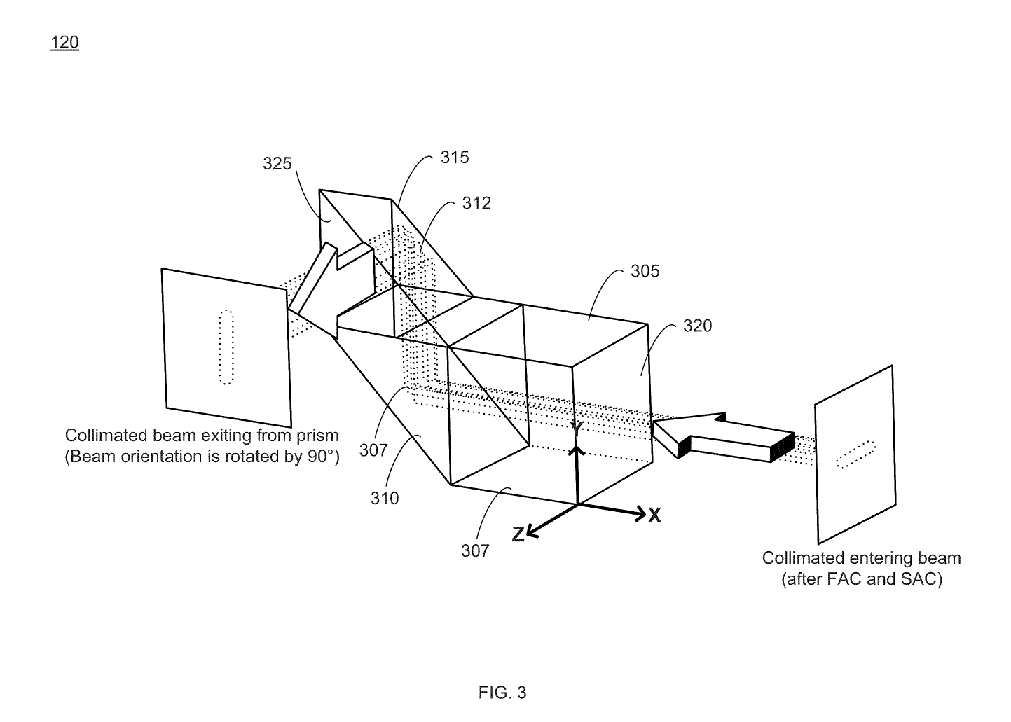

FIG. 3 is an illustration of the prism 120 used in FIG. 1. Functionally, the prism 120 can be divided into three parts: a cube 305, and two orthogonal right angle prisms 310 and 315. In some embodiments, one or more of the parts may physically be a single monolithic part. For example, the prism 120 may be a single monolithic structure. In other embodiments, the prism 120 is constructed of separate parts that are bonded together.

The cube 305 includes a mounting surface 307 that provides good registration to a flat mounting surface and rigid attachment. In some embodiments, one or more of the surfaces of the cube (e.g., an entrance plane 320) are coated to minimize any reflection over the beam wavelength or range of wavelengths. A collimated beam leaving a collimator assembly (e.g., a FAC and a SAC) enters the cube at the entrance plane 320 and is transmitted to the right angle prism 310.

In alternate embodiments, the cube 305 does not have to be a cube-shape, nor does it have to be located in the optical path as shown. Additionally, in some embodiments, the height of the cube 305 in the Y direction may be such that beam passes over the cube and the entrance plane located at the right angle prism 310. The primary purpose of the cube in FIG. 3 is to provide good registration and rigid attachment to the flat mounting surface. Other structures can be used to perform this same function.

After exiting the cube 305, the beam is reflected, via total internal reflection (TIR), by the hypotenuse 307 (first reflecting surface) the right angle prism 310 and again by the hypotenuse 312 (second reflecting surface) of the right angle prism 315. The beam then exits the prism 120 at an exit plane 325 in a positive Z direction. In alternate, embodiments, the right angle prism 315 may be rotated such that the beam exits along the negative Z direction, or some other direction. The first reflecting surface (hypotenuse 307) and the second reflecting surface (hypotenuse 312) are polished in order to maximize total reflection of an incident beam. Additionally or alternatively, in some embodiments, the surfaces may be coated with materials to maximize reflection of the beam.

The pair of right angle prisms 310 and 315 perform the following functions. They rotate the orientation of the spatial beam profile of the beam exiting from the prism 120 by 90° compared with the spatial beam profile of the entering beam. They elevate the optical axis of the beam. They bend the beam propagation direction by 90°.

The pair of right angle prisms 310 and 315 preferably is designed so that the exit beam exits close to one of the edges of a second right angle prism (e.g., 120b). The optical axis of the exiting beam preferably is within Δh/2 of the edge. This is because, as shown in FIG. 1, the horizontal beam stacking is achieved by shifting each prism 120a-120d in the X-direction by Δh with respect to each other. If the exiting beam is too far from the edge, then the exiting beam may be obstructed by the other prisms closer to the focusing lens 125.

The refractive index of a chosen glass for prism 120 should be high enough so that TIR can happen for all rays of the incoming beam, taking into consideration any residual divergence of the collimated beam and misalignments. For example, the prism 120 may be composed of fused silica, glass, BK7, or any other material that can achieve TIR with low absorption.

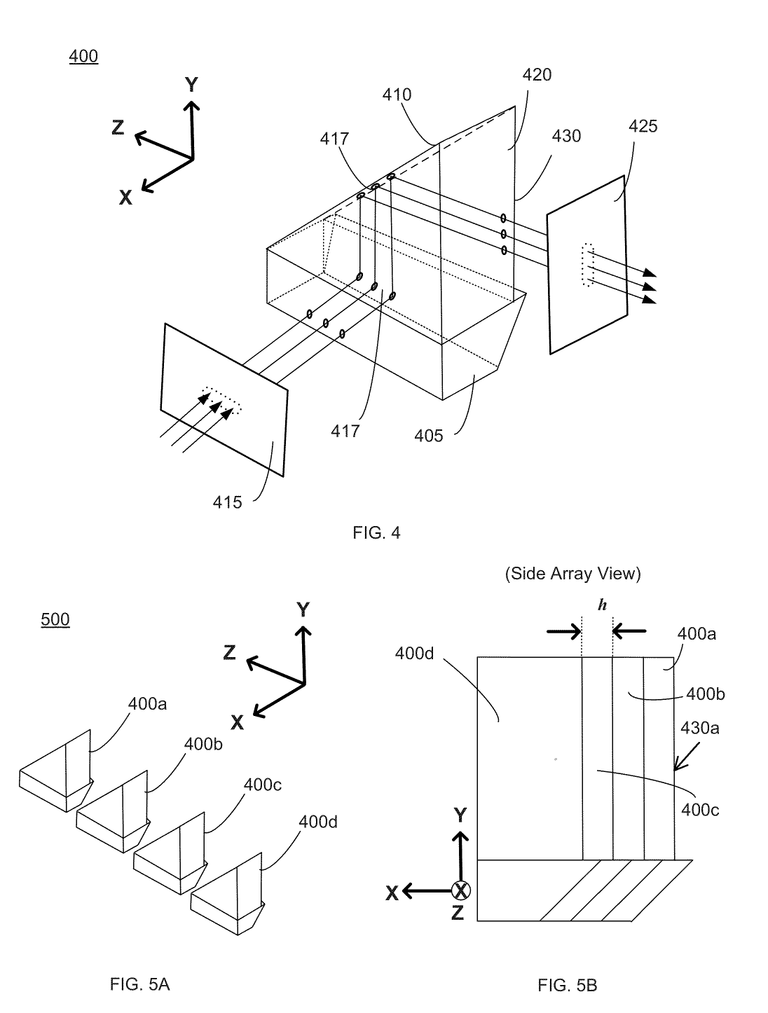

FIG. 4 is an illustration of another suitable prism design 400 according to an embodiment. In this example, the functional aspects of the “cube” 305 and first right angle prism 310 are a single component 405, and the second right angle prism 315 is a second component 410. A beam with spatial beam profile 415 entering component 405 is reflected, via TIR, off a back surface 417 (first reflecting surface) of the component 405. The reflected beam then is then reflected, via TIR, a second time off the hypotenuse 419 (second reflecting surface) of the component 410 before exiting the prism 400, at an exit plane 420, along the negative Z direction with a spatial beam profile 425. The spatial beam profile 425 of the beam is rotated 90 degrees with respect to the spatial beam profile 415. In alternate, embodiments, the component 410 may be rotated such that the beam exits the prism, via the exit plane 420, along the positive Z direction, or some other direction. The first reflecting surface (back surface 417) and the second reflecting surface (hypotenuse 419) are polished in order to maximize total reflection of an incident beam. Additionally, in some embodiments, the surfaces may be coated with materials to maximize reflection of the beam.

In some embodiments, the components 405 and 410 may physically be a single monolithic part. In other embodiments, the components 405 and 410 are separate parts that are bonded together.

Additionally, the refractive index of a chosen glass for prism 400 should be high enough so that TIR can happen for all rays of the incoming beam, taking into consideration any residual divergence of the collimated beam and misalignments. For example, the prism 400 may be composed of fused silica, glass, BK7, or any other material that can achieve TIR with low absorption.

FIG. 5A shows an array 500 of the prisms in FIG. 4 according to an embodiment. The array 500 includes prisms 400a-400d. Referring back to FIG. 4, each of the prisms 400a-400d is preferably is designed so that the exit beam exits close to an edge of the component 410 that is above the reflecting surface of the component 405. For example, for this particular orientation of the component 410, the exit beam exits close to an edge 430.

The optical axis of the exiting beam preferably is within Δh/2 of the edge 430. This is because the horizontal beam stacking is achieved by shifting each prism 400a-400d in the X-direction by Ah with respect to each other. FIG. 5B shows a side view of the array 500 of the prisms 400a-400d in FIG. 5A according to an embodiment. For example, if the exiting beam of prism 420a is too far from the edge 430a, then the existing beam may be obstructed by an adjacent prism.

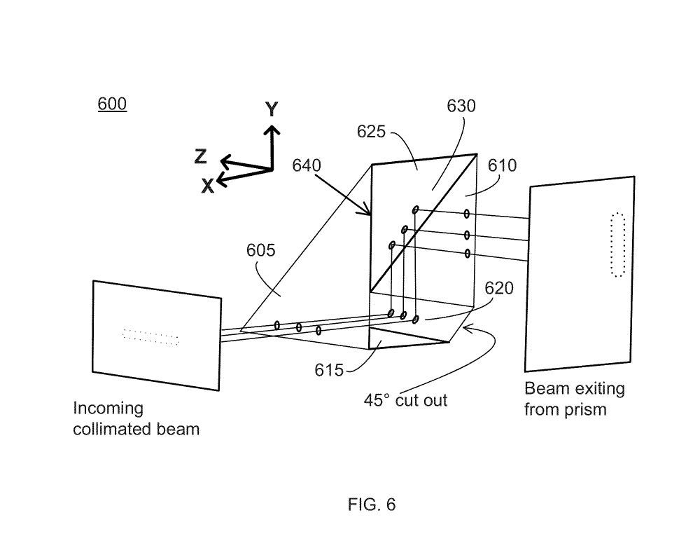

FIG. 6 is an illustration of yet another prism 600. Prism 600 has a beam entering surface 605, a far side surface 610, a bottom surface 615, a first reflecting surface 620, a second reflecting surface 625, and a beam exiting surface 630. Prism 600 is a monolithic structure. In alternate embodiments, the prism 600 is composed of one or more parts. Additionally, in some embodiments, one or more of the surfaces 605 and 630 may be coated with materials to maximize transmission of a beam.

The beam entering surface 605 is triangular in shape. The beam entering surface 605 includes an edge 640 that is perpendicular to the bottom surface 615. The beam exiting surface 630 intersects the edge 640. The far side surface 610 is parallel to the beam entering surface 605 and is also triangular in shape.

Prism 600 is a modified right angle prism. The modification is the first reflecting surface 620 which is a 45° cut out between the far side surface 610 and the bottom surface 615 of the prism 600. The first reflecting surface 620 and the second reflecting surface 625 are polished in order to maximize total reflection of an incident beam. In alternate embodiments, the angle of the first reflecting surface 620 and/or the second reflecting surface with respect to the bottom surface 615 may be angles other than 45 degrees. Additionally or alternatively, in some embodiments, one or more of the surfaces 620 and 625 may be coated with materials to maximize reflection of the beam.

Functionally, the first reflecting surface 620 acts as the first right angle prism 310 in FIG. 3. Similarly, the second reflecting surface 625 (i.e., the hypotenuse of the prism 600) acts as the second right angle prism 315. For example, a collimated beam perpendicular to, and incident on, the beam entering surface 605 is transmitted by the beam entering surface 605. The collimated beam is reflected by the first reflecting surface 620 and the second reflecting surface 625 resulting in a vertical offset to the collimated beam and rotating the collimated beam such that a spatial beam profile of the collimated beam is rotated by 90 degrees. The collimated beam then exits the prism 600 via the exiting surface 630.

In alternate embodiments, the prism 600 may be modified such that the beam exits in the positive Z direction. The bottom surface 615 provides registration and attachment to a flat surface.

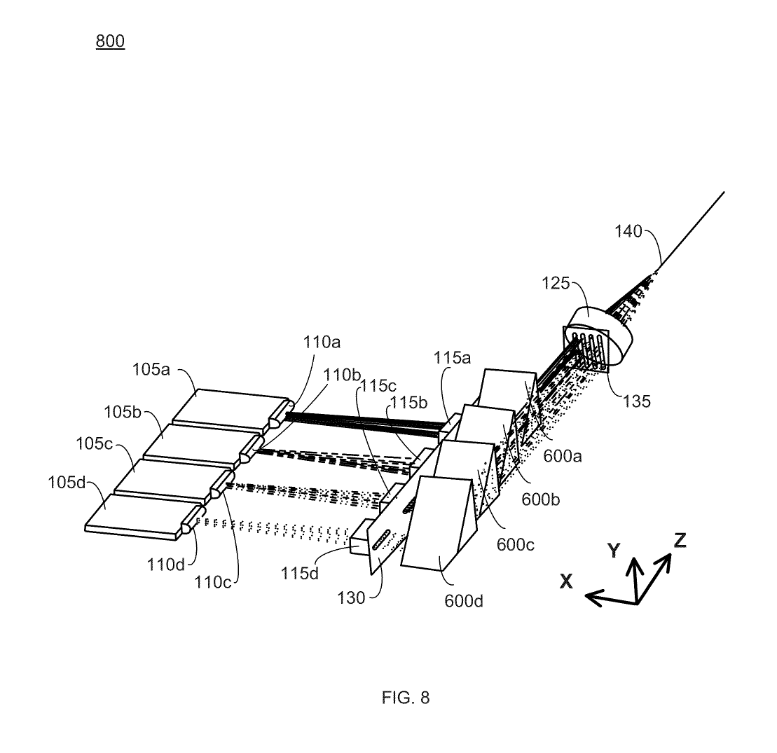

The prism 600 provides a pair of opposing surfaces, the beam entering surface 605 and the far side surface 610, that are easily gripped without interfering with the collimated beam (or some other laser light used for alignment) entering or exiting the prism 600. This is extremely useful while aligning the prism 600 when it is part of a larger assembly (e.g., assembly 800 discussed below). For example, the prism 600 may be gripped via the opposing surfaces using a tool. The position of the prism 600 may then be adjusted with the tool such that the collimated beam is properly aligned. Thus, facilitating precise alignment of the prism 600 within a larger assembly (e.g., as shown in FIG. 8) without interfering with the collimate beam.

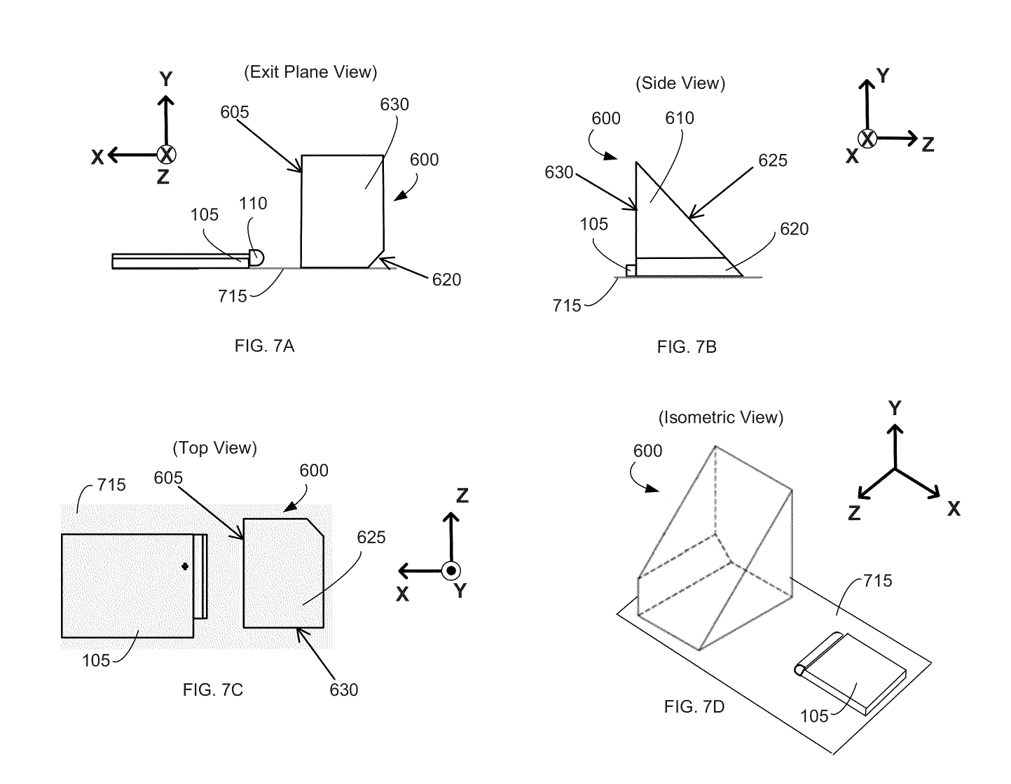

FIGS. 7A-7D illustrate different views of the prism 600 in combination with a COS 105. FIGS. 7A illustrates an exit plane view of the combination of a COS 105 with the prism 600. FIG. 7B illustrates a side view of the combination of a COS 105 with the prism 600. FIG. 7C illustrates a top view of the combination of a COS 105 with the prism 600. In each of FIGS. 7A-7C the prism 600 and the COS 105 are mounted on a flat surface 715. FIGS. 7D illustrates an isometric view of the combination of a chip on submount with the prism of FIG. 6 according to an embodiment.

FIG. 8 illustrates a bank of four COS using the prism of FIG. 6. In FIG. 8, each prism 600 is positioned such that it is staggered laterally with respect to adjacent prism. Note one difference between FIG. 8 and FIG. 1 is the following. In FIG. 8 the beams exit from the righthand side of the prisms' beam exiting surfaces ( beam exiting surface 630), whereas in FIG. 1 the beams exit from the lefthand side of prisms' beam exiting surfaces (i.e., exit plane 325) (where right is defined as the −x direction and left is defined as the +x direction). As a result, travelling from the prism farthest (i.e., prism 600d) from the focusing lens 125 to the one nearest (i.e., prism 600a) to the focusing lens 125, in FIG. 8 each successive prism is shifted to the left whereas in FIG. 1 each successive prism is shifted to the right. The COSs 105a-105d, the FACs 110a-110d, the SACs 115a-115d, and the prisms 600a-600d are all mounted (e.g., bonded or attached via some other means) to a common surface in the X-Z plane. The diode active area heights at each of the COSs 105a-105d are the same as the heights of the collimated beams (at beam center) before entering the prisms 600a-600d. In alternate embodiments, the FACs 110a-110d are bonded directly to their respective COSs 105a-105d, instead of being bonded to the common surface.

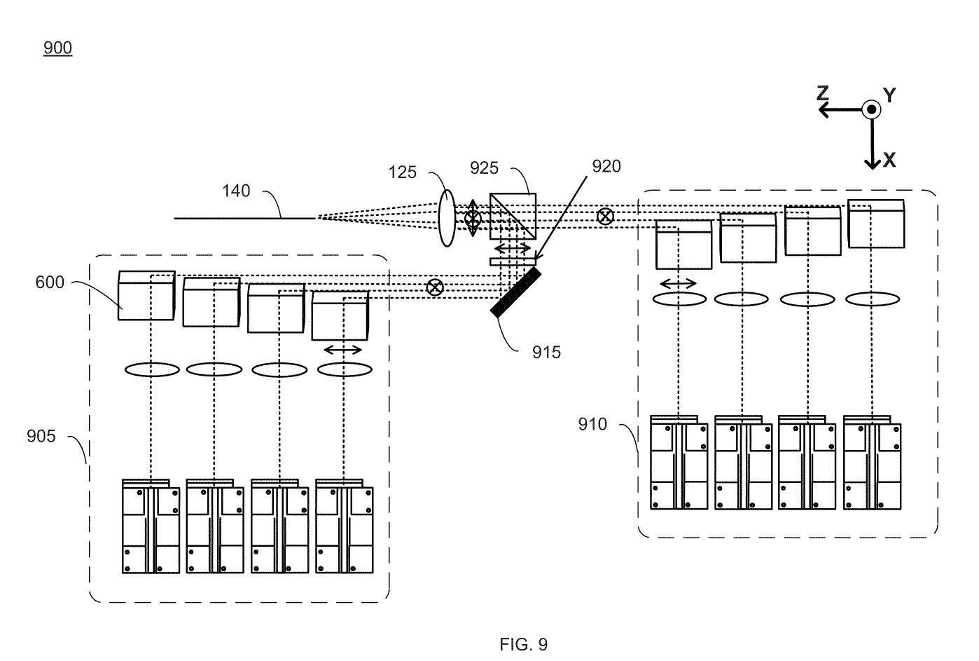

FIG. 9 is an example assembly 900 for spatial multiplexing laser diode beams using the prism 600 shown in FIG. 6. The assembly 900 includes a subassembly 905, a subassembly 910, an overlay mirror 915, a half-wave plate 920, a polarization beam combiner 925, a focusing lens 125, and a fiber 140. In this example, each subassembly 905 and 910 contains a bank of four laser diodes. For each laser diode there is a corresponding SAC, a FAC, and a prism. Within each bank, the four laser diode beams are combined using the approach described with reference to FIGS. 6-8. In subassembly 905, the prism corresponding to each laser diode is a prism 600. In subassembly 910, the prism corresponding to each laser diode is a prism 600 that has been modified such that the beam exits in the positive Z direction. The components for each subassembly 905 and 910 are all mounted to a common surface in the X-Z plane. The diode active area heights at each of the COSs are the same as the heights of the collimated beams (at beam center) before entering the prisms 600. In alternate embodiments, the FACs are bonded directly to their respective COSs, instead of being bonded to the common surface.

The overlay mirror 915 directs the beams from the subassembly 905 to the half-wave plate 920. The half-wave plate 920 rotates the polarization of the beams 90 degrees. The beams from the two subassemblies are then combined using the polarization beam combiner 925. Although the beam orientation is rotated by 90° on the exit plane of the prisms described in previous embodiments, the polarization is still maintained in the slow-axis direction. Therefore, a polarization combination technique can be used to enhance brightness. Two different prism designs (left-to-right inverted prisms) may be used, one for each bank, in order to reduce the overall area required.

FIGS. 1-9 spatially multiplex laser diode beams by transforming the beams from horizontally elongated to vertically elongated cross sections, and then horizontally stacking the vertically elongated beams as shown in FIG. 2. This approach was illustrated using a pair of 45°-angled reflecting surfaces. In the specific embodiments shown, the pair of angled surfaces were implemented as TIR in right angle prisms. However, the approach is not limited to these specific examples. For example, other angles for reflecting surfaces may be used which may be coated to maximize reflection.

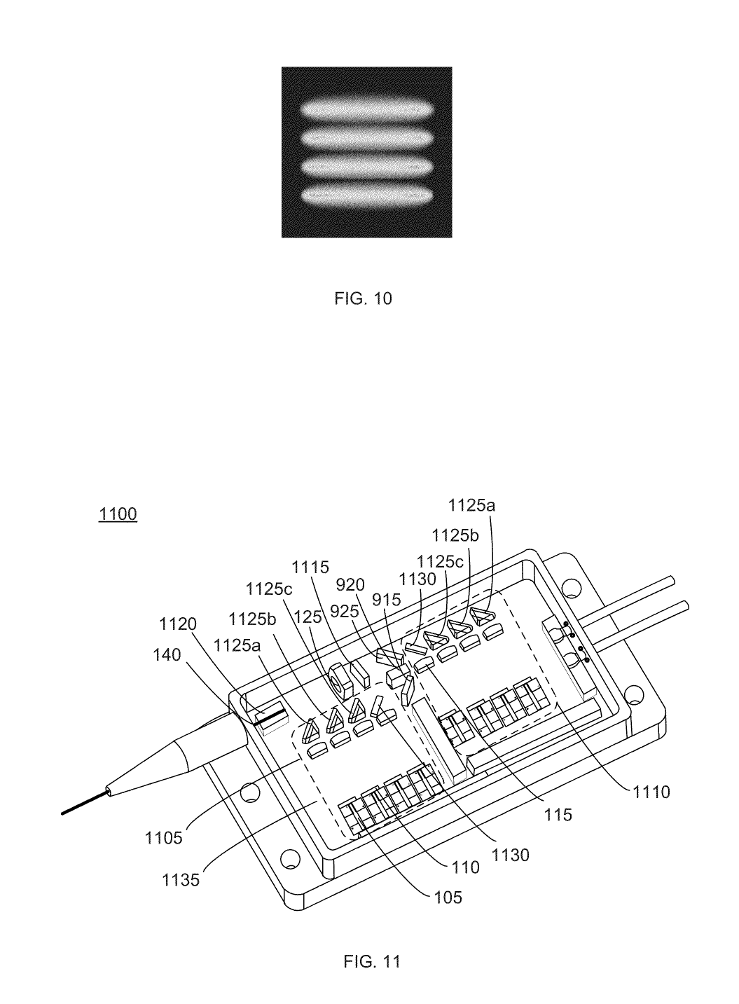

FIGS. 10-13 illustrate a different approach based on vertically stacking the originally horizontally elongated beams. FIG. 10 shows a spatial beam profile of vertically stacked laser diode beams according to an embodiment. The spatial beam pattern of each beam having at least one elongated horizontal side adjacent to one elongated horizontal side of another beam's spatial beam pattern. The four horizontally elongated beams are spaced apart by Ah in the Y direction. Typical values of Ah range from, for example, ˜200 to 700 microns.

FIG. 11 is an example assembly 1100 for spatial multiplexing laser diode beams, to produce the vertical stacking shown in FIG. 10 according to an embodiment. The assembly 1100 includes a subassembly 1105 and subassembly 1110, an overlay mirror 915, a half wave plate 920, a polarization beam combiner 925, a feedback isolation filter 1115, a focusing lens 125, a fiber shim 1120, and a fiber 140.

Each subassembly 1105 and 1110 produces a vertically stacked beam with a spatial beam profile similar to that of FIG. 10. The beams from each subassembly 1105 and 1110 are combined using the overlay mirror 915, the half wave plate 920, and the polarization beam combiner 925 in a manner similar to that described above with reference to FIG. 9.

The combined beams then pass through the feedback isolation filter 1115. The feedback isolation filter 1115 is a filter that attenuates any feedback signal from the fiber 140. For example, the fiber 140 may be part of a fiber laser (e.g., gain medium) that produces a feedback beam (e.g., at 1300 nm). The feedback isolation filter 1115 attenuates the feedback beam to prevent possible damage to components (e.g., laser diodes) of the assembly 1100. In alternate embodiments, the assembly 1100 does not include the feedback isolation filter 1115.

The combined beams are then coupled to the fiber 140 via the focusing lens 125. In this embodiment, the fiber 140 is attached to a fiber shim 1120 which holds the fiber 140 in position.

Each subassembly 1105 and 1110 includes a bank of four COS 105, four FACs 110, four SACs 114, three prisms 1125a-1125c, and a reflector 1130 that are mounted (e.g., bonded or attached via some other means) to a common flat surface 1135. The diode active area heights at each of the COSs 105 are the same as the heights of the collimated beams (at beam center) before entering the prisms 1125a-1125c and the reflectors 1130. In alternate embodiments, the FACs are bonded directly to their respective COSs, instead of being bonded to the common surface 1135.

Each subassembly 1105 and 1110 produces a beam cross section similar to the one shown in FIG. 10. In FIG. 11, the offset in the vertical direction is produced by prisms 1125a-1125c. For example, in subassembly 1110, the beam produced by the laser diode closest to the focusing lens 125 is turned by a mirror 1130 (i.e., no vertical offset). The beam produced by the next laser diode is turned by the prism 1125a, which both turns the beam and vertically offsets it. The beam produced by the next laser diode is turned by the prism 1125b, but with a greater vertical offset, and so on.

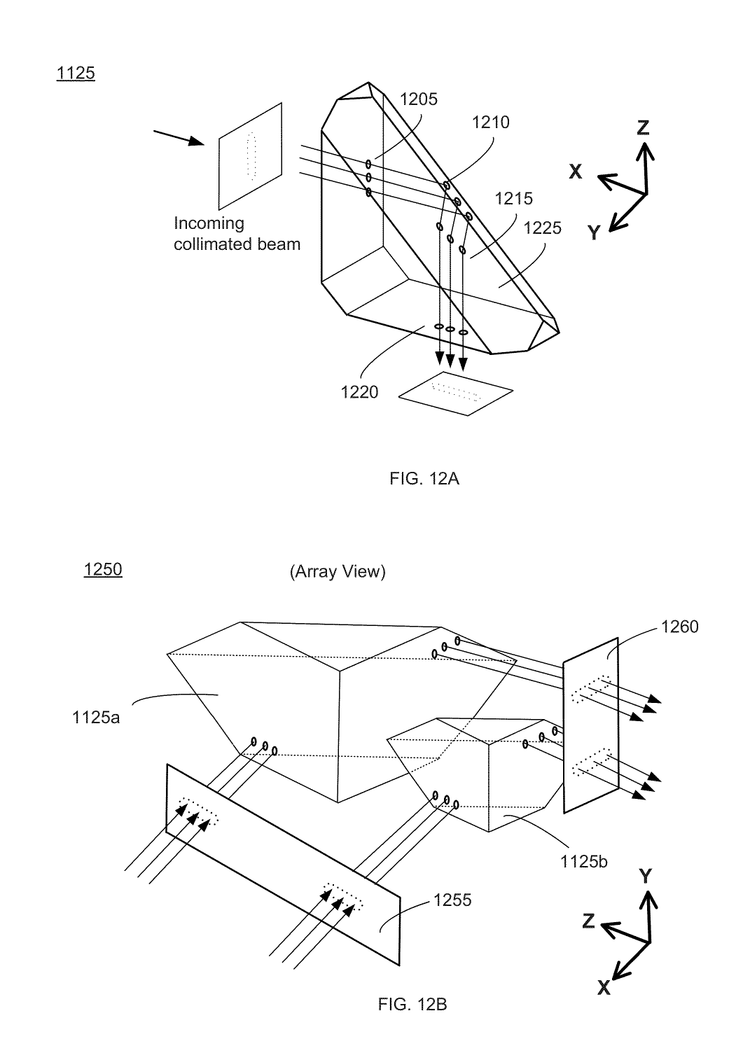

The dimensions of each prism 1125a-1125c within a subassembly are chosen such that the beam exiting each of the prisms 1125a-1125c and the reflector 1130 are vertically stacked in the manner shown in FIG. 10. Each prism 1125 is an Amici roof prism, with slightly different dimensions. The dimensions of the prism 1125c are such that the beam exiting prism 1125c passes above (in the Y direction) the reflector 1130. Likewise, the dimensions of the prism 1125b are such that the beam exiting prism 1125b passes above the prism 1125a, and the dimensions of the prism 1125c are such that the beam exiting prism 1125c passes above the prism 1125b. Accordingly, the width and height of prisms 1125a, 1125b, and 1125c are different from each other, as discussed below with reference to FIG. 12B.

The reflector 1130 is a mirror that has high reflectance at the wavelength or band of wavelengths of the beams produced by the COS 105. In alternate embodiments, the reflector 1130 may be replaced with, for example, a right angle prism.

FIG. 12A is an illustration of a prism 1125 and its operation. Prism 1125 is a monolithic structure. Prism 1125 has a beam entering surface 1205, a first reflecting surface 1210, a second reflecting surface 1215, a beam exiting surface 1220, and a mounting surface 1225. The prism 1125 is generally shaped like a standard right-angled prism with an additional “roof” section (consisting of the first reflecting surface 1210 and the second reflecting surface 1215 meeting at a 90° angle) on the longest side. Total internal reflection from the roof section flips the image laterally. Additionally, in some embodiments, the first reflecting surface 1210 and the second reflecting surface 1215 of the prism 1125 are coated with materials to maximize reflection of the beam.

FIG. 12B shows an array 1250 of the prisms in FIG. 11 according to an embodiment. The array 1250 includes prisms 1125a and 1125b from subassembly 1105. The dimensions of the prisms 1125a and 1125b are different from one another. Specifically, prism 1125a is larger than prism 1125b. Prism 1125a is simply prism 1125b scaled to larger dimensions. The size differential is such that the beam exiting prism 1125 a passes over prism 1125b. Likewise, the prism 1125b would be larger than prism 1125c (not shown), such that the beam exiting prism 1125b exits over the prism 1125c. The collimated beams entering the array 1250 are at the same height in the Y direction with a spatial beam profile as shown in plane 1255. Additionally, each of the prisms 1125 are aligned such that the beams exiting the prisms are vertically stacked as shown in plane 1260.

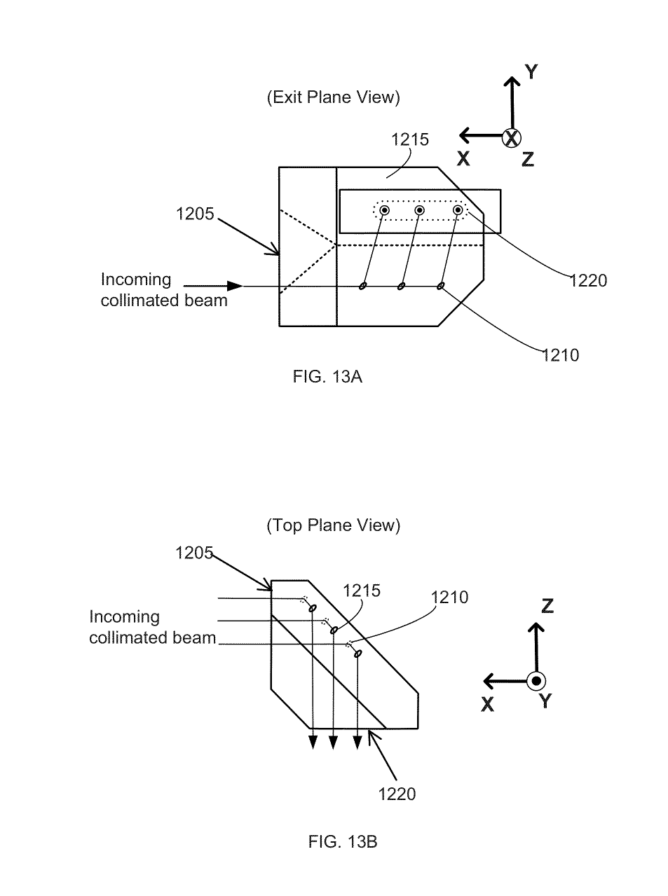

FIGS. 13A-13B illustrate different views of the prism 1125. FIG. 13A illustrates an exit plane view of the Amici roof prism 1125 in FIG. 12A according to an embodiment. FIG. 13B illustrates a top view of the Amici roof prism 1125 in FIG. 12A according to an embodiment.

One advantage of this approach is that the COSs 105, SACs 105 and prisms can be attached on a common flat surface. As with FIGS. 1-9, FIGS. 10-13 are examples and the disclosure is not limited to these examples. Other arrangements and variations of Amici roof prisms can be used. In addition, devices other than Amici roof prisms can be used to produce the vertical offset.

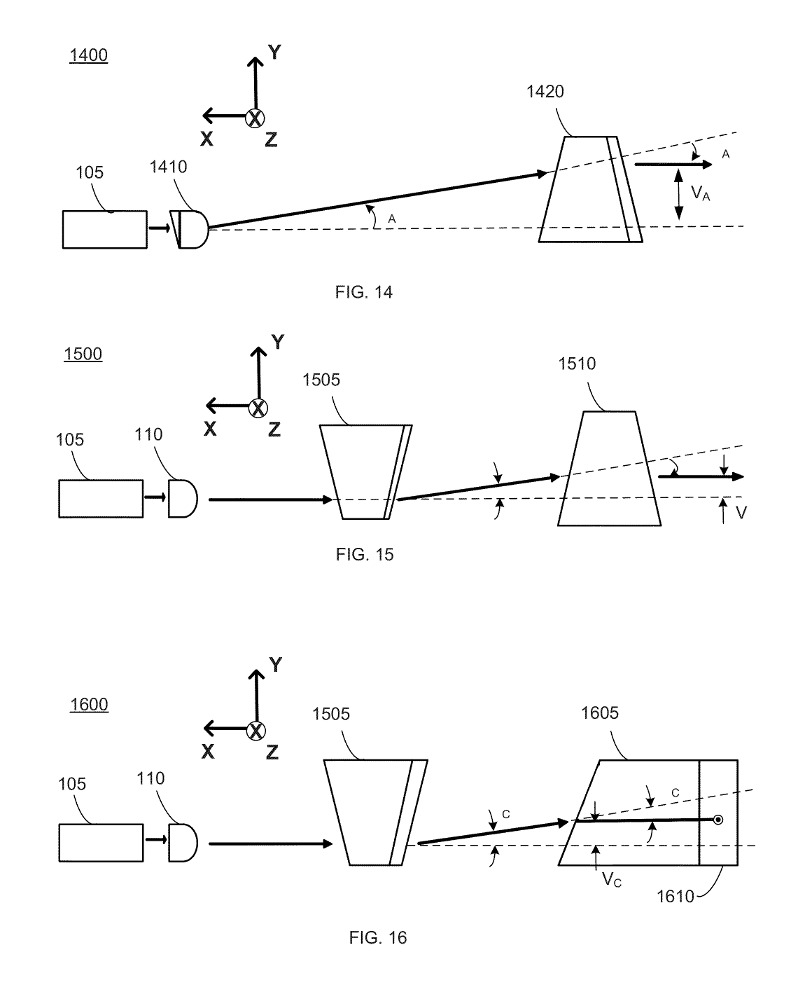

FIGS. 14-16 illustrate yet other approaches where vertical offset is produced by inclining the direction of beam propagation and allowing the beam to propagate along the inclined direction to achieve a certain vertical offset. The amount of vertical offset, ΔV, can be changed by changing the angle of inclination and/or the distance over which the inclined beam propagates.

FIG. 14 illustrates an example optical system 1400 for producing vertically offset laser diode beams, according to an embodiment. The system 1400 includes a COS 105, a FAC with wedge 1410, and a SAC with wedge 1420. The FAC with wedge 1410 collimates the fast axis of the beam generated by the COS 105 and deflects the beam by a fixed angle, θ_{A}. The SAC with wedge 1420 collimates the slow axis of the beam and deflects the beam by a fixed angle, −θ_{A}. The beam exiting the SAC with wedge 1420 is vertically offset from the beam generated by the COS 105 by a distance of ΔV_{A}. The double line on the SAC with wedge 1420 represents that the optical element has a curved face from which the beam exits. The FAC with wedge 1410 and the SAC with wedge 1420 may be composed of fused silica, glass, BK7, or some other material. Additionally, the material may have a low or high index of refraction, however, a high index of refraction is preferred.

FIG. 15 illustrates an example optical system 1500 for producing vertically offset laser diode beams, according to another embodiment. The system 1500 includes a COS 105, a FAC 110, a SAC with wedge 1505, and a wedge 1510. The SAC with wedge 1505 collimates the slow axis of the beam and deflects the beam by a fixed angle, θ_{B}. The wedge 1510 deflects the beam by a fixed angle, −θ_{B}. The beam exiting the wedge 1510 is vertically offset from the beam generated by the COS 105 by a distance of ΔV_{B}. The double line on the SAC with wedge 1505 represents that the optical element has a curved face from which the beam exits. The SAC with wedge 1505 and the wedge 1510 may be composed of fused silica, glass, BK7, or some other material. Additionally, the material may have a low or high index of refraction, however, a high index of refraction is preferred.

FIG. 16 illustrates an example optical system 1600 for producing vertically offset laser diode beams, according to yet another embodiment. The system 1600 includes a COS 105, a FAC 110, a SAC with wedge 1505, and a reflecting wedge 1605. The SAC with wedge 1505 collimates the slow axis of the beam and deflects the beam by a fixed angle, θ_{C}. The reflecting wedge 1605 deflects the beam by a fixed angle, −θ_{C}, and reflects the beam 90 degrees. For example, the reflecting wedge 1605 may contain a 45 degree polished surface (or mirrored surface) such that the beam undergoes TIR and is reflected toward the positive Z direction. The beam exiting the reflecting wedge 1605 is vertically offset from the beam generated by the COS 105 by a distance of ΔV_{C}, and is bent to propagate in the positive Z direction. In alternate embodiments, the reflecting wedge 1605 may be modified such that the exiting beam propagates in the negative Z direction, or some other direction. The reflecting wedge 1605 may be composed of fused silica, glass, BK7, or some other material. Additionally, the material may have a low or high index of refraction, however, a high index of refraction is preferred.

Additionally, pluralities of assemblies described by FIGS. 14-16 may be used to create a stacked beam. In some embodiments, the same assembly is used to the stacked beam (e.g., FIG. 14), in alternate embodiments combinations of different assemblies are used to create the stacked beam (e.g., FIG. 14 and FIG. 15). In some embodiments, the stacked beam may be combined with a second stacked beam using, for example, the methods described above with reference to FIG. 9.

The combination of components uses to create a collimated beam may be referred to as a collimating assembly. For example, a FAC and its respective SAC embody a collimating assembly. Additionally, in some embodiments, the collimating assembly may include one or more wedges or other components which add a vertical offset to the collimated beam.

A redirecting device is used to re-direct the collimated beam exiting a collimating assembly toward, for example, a focusing lens or some other optical element. Examples of redirecting devices are the prisms 120, 400, 600, and 1125, the reflector 130, etc.

Alignment of the optical elements in one or more of the assemblies described above may be automatic or manual. In some embodiments, the optical elements are actively aligned using, e.g., a far field and near field camera and a 6 axis manipulator. Once the components are properly aligned they are mounted to a common surface. For example, prisms 120a-120d may be glued to a common surface. Additionally, in some embodiments, the common surface may include guide lines as a starting point for one or more optical elements to help facilitate active alignment.

The assemblies (e.g., 100, 800, 900, and 1100) described above have a dedicated COS 105 and dedicated optics (e.g., FAC, SAC, and prism) for each laser diode. Separate COSs for each laser diode have thermal advantages over systems that have multiple laser diodes mounted on the same COS. For example, separate COSs for each laser diode are able to dissipate heat faster and evenly when compared to systems that include multiple laser diodes on a single COS. Additionally, systems that include multiple laser diodes on a single COS generally require larger optics area, and the cost of optical elements generally scales with area. Accordingly, there is a cost advantage in having separate optics for each COS.

Although the detailed description contains many specifics, these should not be construed as limiting the scope of the disclosure but merely as illustrating different examples and aspects of the disclosure. It should be appreciated that the scope of the disclosure includes other embodiments not discussed in detail above. Persons skilled in the relevant art can appreciate that many modifications and variations are possible in light of the above disclosure.

In the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

1. An assembly comprising:
a first laser diode that produces a first beam, the first laser diode being part of a first chip on a submount (COS) that is mounted to a flat surface;
a second laser diode that produces a second beam, the second laser diode being part of second COS that is adjacent to the first COS and is mounted to the flat surface;
a first collimating assembly that collimates the first beam to form a first collimated beam, wherein the first collimated beam has a first spatial beam profile;
a second collimating assembly that collimates the second beam to form a second collimated beam that is parallel to the first collimated beam, wherein the second collimated beam has a second spatial beam profile;
a first redirecting device that adds a vertical offset to the first collimated beam, changes the direction of propagation of the first collimated beam and rotates the first spatial beam profile of the first collimated output beam by 90 degrees such that the first spatial beam profile has a first vertical elongated side; and
a second redirecting device, positioned such that second redirecting device is staggered laterally from the first redirecting device, that adds the vertical offset to the second collimated beam, changes the direction of propagation of the second collimated beam such that the second collimated beam is parallel to the first collimated beam exiting the first redirecting device, and rotates the second spatial beam profile of the second collimated output beam by 90 degrees such that the second spatial beam profile has a second vertical elongated side adjacent to the first vertical elongated side, and
wherein the first and second collimated beams exiting the first and second redirecting devices create a first stacked beam.

2. The assembly of claim 1, wherein the first redirecting device comprises:
a mounting surface that attaches the first redirecting device to the flat surface;
a entrance surface that transmits the first collimated beam output from the first collimating assembly;
a first reflecting surface that reflects the first collimated beam such that it is propagating in a vertical direction; and
a second reflecting surface that reflects the first collimated beam reflected by the first reflecting surface such that the first collimated beam is traveling in a direction orthogonal to the direction of beam propagation output from the first collimating assembly.

3. The assembly of claim 2, wherein the first redirecting device comprises:
a block including the mounting surface;
a first right angle prism wherein the hypotenuse of the first right angle prism is the first reflecting surface, the first right angle prism being affixed to the block such that the collimated beam exiting the block enters the first right angle prism and reflects off the first reflecting surface; and
a second right angle prism wherein the hypotenuse of the second right angle prism is the second reflecting surface, the second right angle prism being affixed to the first fight angle prism such that the collimated beam exiting the first right angle prism enters the second right angle prism and reflects off the second reflecting surface.

4. The assembly of claim 3, wherein the block, the first right angle prism, and the second right angle prism form a monolithic structure.

5. The assembly of claim 3, wherein the block and the first right angle prism form a monolithic structure.

6. The assembly of claim 2, wherein the first redirecting device comprises:
a modified right angle prism having a 45° cut out between a triangular face of the modified right angle prism and the bottom of the modified right angle prism to create the first reflecting surface, and the hypotenuse of the modified right angle prism acts as the second reflecting surface.

7. The assembly of claim 2, further comprising:
a focusing lens that couples the first stacked beam to a fiber; and
wherein the first redirecting device is closer to the focusing lens than the second redirecting device and the second redirecting device is offset by a distance equal to the offset between the first and collimated beams in the first stacked beam.

8. The assembly of claim 7, further comprising:
a half-wave plate that changes the polarization of the first stacked beam by 90 degrees such that the polarization of the first stacked beam is orthogonal to a polarization of a second stacked beam;
a polarization beam combiner that combines the first stacked beam exiting the half-wave plate with the second stacked beam to create a combined beam, wherein the combined beam is then coupled to the fiber via the focusing lens.

9. An assembly comprising:
a first laser diode that produces a first beam, the first laser diode being part of a first chip on a submount (COS) that is mounted to a flat surface;
a second laser diode that produces a second beam, the second laser diode being part of a second COS that is adjacent to the first COS and is mounted to the flat surface;
a first collimating assembly that collimates the first beam to form a first collimated beam, wherein the first collimated beam has a first horizontal spatial beam profile with a first horizontal elongated side;
a second collimating assembly that collimates the second beam to form a second collimated beam that is parallel to the first collimated beam, wherein the second collimated beam has a second horizontal spatial beam profile with a second horizontal elongated side;
a first redirecting device that changes the direction of propagation of the first collimated beam; and
a second redirecting device, that adds a vertical offset to the second collimated beam and changes the direction of propagation of the second collimated beam such that the second collimated beam is parallel to the first collimated beam exiting the first redirecting device and the second horizontal elongated side is adjacent to the first horizontal elongated side,
wherein the first and second collimated beams exiting the first and second redirecting devices create a first stacked beam.

10. The assembly of claim 9, further comprising:
a focusing lens that couples the first stacked beam to a fiber; and
wherein the first redirecting device is closer to the focusing lens than the second redirecting device.

11. The assembly of claim 10, further comprising:
a half-wave plate that changes the polarization of the first stacked beam by 90 degrees such that the polarization of the first stacked beam is orthogonal to a polarization of a second stacked beam;
a polarization beam combiner that combines the first stacked beam exiting the half-wave plate with the second stacked beam to create a combined beam, wherein the combined beam is then coupled to the fiber via the focusing lens.

12. The assembly of claim 11, further comprising:
a feedback isolation filter that transmits the combined beam and attenuates a feedback signal from the fiber.

13. The assembly of claim 10, wherein the first redirecting device is a mirror.

14. The assembly of claim 10, wherein the first redirecting device is an Amici roof prism.

15. The assembly of claim 14, wherein the second redirecting device is an Amici roof prism with different dimensions than the first Amici roof prism.

16. A modified right angle prism comprising:
a beam entering surface that is triangular in shape, the beam entering surface including a first edge that is perpendicular to a bottom surface of the modified right angle prism, wherein a collimated beam perpendicular to, and incident on, the beam entering surface is transmitted by the beam entering surface;
a first reflecting surface that is a 45° cut out between a far side surface and a bottom surface of the modified right angle prism, wherein the far side surface is parallel to the beam entering surface;
a second reflecting surface that is the hypotenuse of the modified right angle prism, wherein the collimated beam reflects off the first reflecting surface and then the second reflecting surface, adding a vertical offset to the collimating beam and rotating the collimated beam such that a spatial beam profile of the collimated beam is rotated by 90 degrees; and
a beam exiting surface, rectangular in shape, that transmits the collimated beam reflected from the second reflecting surface, the beam exiting surface intersects the beam exiting surface at the first edge.

17. The modified right angle prism of claim 16, wherein the modified right angle prism is a monolithic structure.

18. The modified right angle prism of claim 16, wherein the first edge is located to the right of the collimated beam incident on the beam entering surface.

19. The modified right angle prism of claim 16, wherein the first edge is located to the left of the collimated beam incident on the beam entering surface.

20. The modified right angle prism of claim 16, wherein at least one of the first reflecting surface or the second reflecting surface is coated to increase reflectivity.
